(19) United States
(12) Patent Application Publication
(10) Pub. No.: US 2021/0123625 A1
(43) Pub. Date: Apr. 29, 2021

(54) LOW-COST COMMISSIONING METHOD FOR THE AIR-CONDITIONING SYSTEMS IN EXISTING LARGE PUBLIC BUILDINGS

(71) Applicant: TIANJIN UNIVERSITY, Tianjin (CN)

(72) Inventors: Ding Yan, Tianjin (CN); Hao Su, Tianjin (CN); Neng Zhu, Tianjin (CN); Daquan Wang, Tianjin (CN); Yiran Li, Tianjin (CN)

(73) Assignee: TIANJIN UNIVERSITY

(21) Appl. No.: 17/138,959

(22) Filed: Dec. 31, 2020

Related U.S. Application Data
(63) Continuation of application No. PCT/CN2019/090250, filed on Jun. 6, 2019.

(30) Foreign Application Priority Data
Nov. 29, 2018 (CN) 201811445280.1
May 8, 2019 (CN) 201920650431.0

(51) Int. Cl. F24F 11/38; F24F 11/47; F24F 11/49; F24F 11/56; F24F 11/64; F24F 11/65; G05B 19/042

(52) U.S. Cl. CPC F24F 11/38; F24F 11/47; F24F 11/49; G05B 2219/2614; F24F 11/64; F24F 11/65; G05B 19/042; F24F 11/56

(57) ABSTRACT

The present disclosure is drawn to a low-cost commissioning method for the air-conditioning systems in existing large public buildings, that mainly aims at the commissioning of the air-conditioning system. The system comprises a system analysis sub-module, a load prediction sub-module, an optimization scheme sub-module, and a control strategy sub-module. The main method in the commissioning system is a low-cost commissioning method for the air-conditioning systems in existing large public buildings.

### CROSS-REFERENCE TO RELATED APPLICATIONS

This application claims priority to Chinese Patent Application No. 201811445280.1, field on Nov. 29, 2018, and No. 201920650431.0, field on May 8, 2019, the entire content of which are incorporated herein by reference.

### TECHNICAL FIELD

The present disclosure belongs to the field of building energy system commissioning, and specifically more relates to the proposal of the operation condition diagnosis, building load prediction and optimization scheme pertinent to the air conditioning systems in existing large public buildings, and particularly relates to a low-cost commissioning method and a commissioning system for the air-conditioning system in existing large public buildings.

### BACKGROUND

Commissioning in the construction industry refers to the supervision and management of the entire process in the design, construction, acceptance and operation and maintenance stages. The purpose is to ensure the building can achieve safe and efficient operation and control in accordance with the requirements of the design and users, and avoid problems caused by design defects, construction quality, and equipment operation from affecting the normal use of the building or even causing major system fault. The disclosure mainly aims at the commissioning of existing buildings, that is, the commissioning in the operation and maintenance phases.

The energy systems in public buildings mainly comprise the air-conditioning system, the lighting system, and the equipment energy system. According to the survey on the energy use situation of the existing large public buildings, it is found that there are many problems with the air conditioning systems. Firstly, the problems of high energy consumption and low management level are common. The current air conditioning systems in China basically use the methods such as variable water temperature control or variable flow control, but it is a common phenomenon that the reasonable and stable operation of the air conditioning system cannot be guaranteed. If static imbalances and dynamic imbalances is occurred in the system, it will inevitably lead to poor cooling and heating effects, and high energy consumption in the air conditioning system. Secondly, if the air conditioning system operates unreasonably, there will often be problems such as ‘big horse pull a small carriage’, uneven cooling and heating and waste energy. Thirdly, the commissioning cost is often relatively high. The traditional commissioning Therefore, based on the above practical problems, the present disclosure proposes a low-cost commissioning system for the air-conditioning systems in existing large public buildings, which includes a low-cost air-conditioning system commissioning method for air-conditioning system in existing large public buildings. The air-conditioning usage situation involved in the method is based on the summary of the field survey and is in line with actual usage situation.

### DETAILED DESCRIPTION

The purpose of the present disclosure is to overcome the shortcomings of the prior art and propose a low-cost commissioning system and method for the air-conditioning systems in existing large public buildings. This disclosure proposes a complete fast and low-cost commissioning system and correspondingly mature low-cost commissioning method with system diagnosis, load prediction, operation optimization, and commissioning strategies for building air-conditioning systems, which provide suggestions and basis for air-conditioning system commissioning of existing large public buildings.

To solve the technical problems in the background art, the present disclosure adopts the following technical proposal: the low-cost commissioning method for air-conditioning system in existing large public building. The low-cost commissioning method for air-conditioning system specifically includes: constructing fault diagnosis model for air-conditioning unit, constructing load prediction model for air-conditioning and constructing optimization model for air-conditioning system.

The specific steps of constructing the fault diagnosis model of the air-conditioning unit are as follows:

First, define input variables: Tₑᵥ, evaporation temperature, ° C.; T_{chws}, evaporator supply water temperature, ° C.; T_{chwr}, evaporator inlet water temperature, ° C.; T_{cwe}, condenser inlet water temperature, ° C.; T_{cwl}, condenser supply water temperature, ° C.; T_{cd}, condensation temperature, ° C.; P, unit power, kW; Tₒₗₗ, lubricating oil tank oil temperature, ° C.; Q_{s,i}, actual flow of i-th parallel circuit loop, m³/h; Q_{d,i}, design flow of i-th parallel circuit loop, m³/h;

(1) Diagnosis of Water Volume on Evaporator Side:

define judgment index A:

A=(T_{chwr}−T_{chws})−T₁ (1)

where, T₁ is an average value of the temperature difference between the inlet and supply water on the evaporator side, which is generally 2.5;

diagnosis results are as follows:

if A>0.3, there is insufficient flow in the evaporator, and frequency of the chilled water pump should be increased;

if −0.3<A<0.3, the evaporator works normally;

if A<−0.3, there is excessive flow in the evaporator, and frequency of the chilled water pump should be reduced.

(2) Diagnosis of Water Volume on Condenser Side:

define judgment index B:

B=(T_{cwl}−T_{cwe})−T₂ (2)

where, T₂ is an average value of the temperature difference between the inlet and supply water on the condenser side, generally 2.5;

diagnosis results are as follows:

if B>0.5, there is insufficient flow in the condenser, and frequency of cooling water pump should be increased;

if −0.3<B<0.3, the condenser works normally;

if B<−0.3, there is excessive flow in the condenser, and the cooling water pump frequency should be reduced.

(3) Diagnosis of Non-Condensable Gas

define judgment index C:

C=T_{cd}−T_{cwl} (3)

diagnosis results are as follows:

if C≤1, system is normal;

if C>1 and 560<P<610, the system contains non-condensable gas, and the non-condensable gas in the system should be eliminated in time;

if C>1 and P>610, there is a possibility of fouling in the condenser. At this point, the condenser fouling should be cleaned in time.

(4) Diagnosis of Lubrication System

diagnosis results are as follows:

if Tₒᵢₗ>54.2, an unit's lubricating oil is excessive. It is recommended to extract excess oil from oil tank.

(5) Diagnosis of Hydraulic Balance of Pipe Network

define judgment index D:

$${D}_{i} = \frac{{Q}_{s , i}}{{Q}_{d , i}} \qquad ( 4 )$$

diagnosis results are as follows:

if Dᵢ is close to 1, a pipe network is hydraulically balanced;

if there is a large difference between Di and 1, there is a hydraulic imbalance in the pipe network. At this point, it is recommended to adjust valves of different loops to ensure that flow of each loop is close to design flow.

The specific steps of constructing air-conditioning load prediction model are as follows:

First, build a model for occupant number in the building. Typical day can be divided into four time periods, morning active time period (08: 30-09: 30), noon break time period (11: 20-13: 00), afternoon active time period (17: 20-18:00) and inactive time period (09: 30-11: 20 and 13: 00-17: 20). After obtaining weekly change in average occupant number per time period, you can use the following formula to fit hourly occupancy in active time periods:

Y=aX³+bX²+cX+d (5)

where Y is occupant number, X is time, and a, b, c, d are the fitting coefficients. The occupant number in inactive time period is basically maintained in a stable state. The last moment value of previous active time period is used as the occupant number of this time period.

Further, construct cooling load prediction model for equipment:

$$\begin{matrix}{Q}_{e} = {q}_{e} {C}_{{LQ}_{e}} & ( 6 ) \\ {q}_{e} = \{ \begin{matrix}{n}_{1} {n}_{2} {N}_{e} Y & \begin{matrix}before and after work time \\ ( 0.35 \leq x \leq 0.42 , 0.72 \leq x \leq 0.75 )\end{matrix} \\ 0.95 {n}_{1} {n}_{2} {N}_{e} Y & lunch break ( 0.47 \leq x \leq 0.54 ) \\ {n}_{1} {n}_{2} {N}_{e} Y & on \text{-} work time\end{matrix} & ( 7 )\end{matrix}$$

where qₑ is equipment heat dissipating capacity, W; C_{LQ}_{ₑ} is cooling load coefficient for sensible heat dissipation of the equipment; n₁ is use efficiency of a single equipment, and the value is 0.15 to 0.25; n₂ is equipment conversion coefficient, the value is 1.1; Nₑ is rated power of a single equipment, W.

Establish time-varying model of occupant cooling load, as follows:

Q_{c}=qₛYφC_{LQ} (8)

where Q_{c} is hourly cooling load formed by human body sensible heat dissipation, W; qₛ is sensible heat dissipation capacity of adult men at different room temperature and with different labor characteristics, W; φ is clustering coefficient; C_{LQ} is cooling load coefficient for sensible heat dissipation of human body.

The specific steps of establishing time-varying model of lighting cooling load are as follows:
1) For a building with multiple lighting partitions, luminaire turn-on rate is calculated according to the following formula:

$${U}_{j} = \frac{{\sum }_{i = 1}^{j} {m}_{i}}{n} \times 100 \% j ∈ [ 1 , k ] \qquad ( 9 )$$

where j is number of lighting partitions; Uⱼ is luminaire turn-on rate when j lighting partitions are turned on, %; k is number of architectural lighting partitions; mᵢ is number of luminaires in the i-th lighting partition; n is total number of luminaires in lighting zones.
2) lighting cooling load of a building can be calculated using the following formula:

$${Q}_{L} = \{ \begin{matrix}0 & before work time 0 \leq x \leq 0.33 , y = 0 \\ α {U}_{j} {nW}_{L} {C}_{QL} & on \text{-} work time 0.33 \leq x \leq 0.83 , 0 < \\ 0 & off \text{-} work time 0.83 \leq x \leq 1 , y = 0\end{matrix} \qquad ( 10 )$$

Where Q_{L} is the instantaneous cooling load of the lighting, W; α is the correction coefficient; W_{L} is the power required by the lighting fixture, W; C_{QL} is the cooling load coefficient for sensible heat dissipation of the lighting.

building interior cooling load calculation formula is as follows:

Qₜ=Q_{c}+Qₑ+Q_{L} (11)

The cooling load prediction model of the building envelope is as follows:

Qₜₛ=Σₖ₌₁^{SURF}(tᵣ−tₙ)(AₖFₖ) (12)

where Qₜₛ is hourly cooling load of the building envelope, W; A is area of the building envelope, m²; SURF is number of building envelope; F is heat transfer coefficient of the building envelope, W/(m²·K); tᵣ is outdoor air calculated daily hourly temperature, ° C.; tₙ is indoor design temperature, ° C.

solar radiation cooling load prediction model is as follows:

Qₜᵣ=Σₖ₌₁^{EXP}(X_{g}X_{d}X_{z})Rᵢ (13)

Where Qₜᵣ is the hourly cooling load of solar radiation, W; R is the solar heat gain of the window, W/m²; X_{g} [symbol] X_{d} [symbol] X_{z} are the structure correction coefficient, location correction coefficient, and barrier coefficient of the window; EXP is the number of windows.

Building exterior cooling load prediction model, a calculation formula is as follows:

Qₜ=Qₜₛ+Qₜᵣ (14)

Establish the building fresh air load prediction model, the formula is as follows:

$$\begin{matrix} {Q}_{f} = {Q}_{fs} + {Q}_{fl} & ( 15 ) \\ {Q}_{fs} = \{ \begin{matrix}{C}_{p} NyV ρ ( {t}_{τ} - {t}_{n} ) & on \text{-} work time 0.33 \leq x \leq 0.83 , 0 < Y \\ 0 & before work time 0 \leq x \leq 0.33 , Y = 0 \\ 0 & off \text{-} work time 0.83 \leq x \leq 1 , Y = 0\end{matrix} & ( 16 ) \\ {Q}_{fl} = \{ \begin{matrix}{r}_{t} NyV ρ ( {d}_{τ} - {d}_{n} ) & on \text{-} work time 0.33 \leq x \leq 0.83 , 0 < Y \\ 0 & before work time 0 \leq x \leq 0.33 , Y = 0 \\ 0 & off \text{-} work time 0.83 \leq x \leq 1 , Y = 0\end{matrix} & ( 17 )\end{matrix}$$

where Q_{f} [symbol] Q_{fs} [symbol] Q_{fl} are ee air load, sensible heat load, and latent heat load, respectively, W/m²; dᵣ [symbol] dₙ are outdoor air humidity and indoor air humidity, respectively, kg(water)/kg(dry air); Cₚ is specific heat capacity of air, 1.01 kJ/kg; ρ is air density, 1.293 g/m³; V is fresh air volume required by a single person, and the size is 30 m³/(h·person); rₜ is latent heat of vaporization of water, 1718 kJ/kg.

hourly cooling load model of the building is calculated according to the following formula:

Q=Qᵢ+Qₜ+Q_{f} (18)

In the case of long-term operation, cooling capacity of unit and building load should maintain a dynamic balance. It is considered that the cooling capacity of unit is equal to cooling load of the building.

The specific steps of constructing air-conditioning system optimization model are as follows:

First, construct an energy consumption model of chillers. The energy consumption of the chiller can be obtained by the following formula fitting:

P₁=c₁+c₂·T₁+c₃·T₂+c₄·Q (19)

Where: P₁-energy consumption of chillers, kW;
c₁ [symbol] c₂ [symbol] c₃ and c₄-parameters of each item;
T₁—chilled water return temperature, ° C.;
T₂—cooling water supply temperature, ° C.;
Q—actual cooling capacity, kW.
cooling water side pump and chilled water side pump energy consumption models can use: model of cooling water pump and chilled water pump is as follows:

P₂=g₁+g₂·m (20)
where P₂—Energy consumption of cooling water side pump and chilled water side pump, kW
g₁ [symbol] g₂—parameters of each item;
m—actual flow of the pump, m3/h.

Energy consumption of air-conditioning system is the sum of the energy consumption of the above three equipment.

When the cooling load of building is determined at a certain moment, optimal working point with the lowest system energy consumption can be determined by the optimization algorithm and corresponding constraint condition.

Specific process of the algorithm is as follows:

(1) setting normal operating ranges of the cooling water supply and return temperature, chilled water supply and return temperature, cooling water supply and return temperature difference, chilled water supply and return temperature difference, cooling water flow and chilled water flow.
(2) establishing an expression for the energy consumption of HVAC system, which is related to the cooling water supply and return temperature, chilled water supply and return temperature, and cooling load;
(3) Inputting cooling load value at predicted time. program will randomly select a set of parameters in the cooling water supply and return temperature and the chilled water supply and return temperature to calculate the energy consumption value and record it as E1; compare E1 to a reference value, which is much greater than the possible energy consumption value.

If E1 is less than the reference value, then the reference value is replaced by E1 as reference energy consumption value for further calculation;

(4) Continue to randomly select a set of parameters to calculate the energy consumption value and record it as E2.

If E2 is less than E1, E1 is replaced by E2 as reference energy consumption value;

if E2 is greater than E1, then retain E1 as reference energy consumption value;

(5) Continue the process in (4) until the minimum energy consumption value Ei is found, and output it together with the corresponding parameter group.

Commissioning system based on an existing large public building air-conditioning system, which includes a system analysis sub-module, a load prediction sub-module, an optimization scheme sub-module and a control strategy sub-module.

The system analysis sub-module obtains a preliminary analysis of operation status of chillers and a hydraulic analysis of the pipe network by constructing a fault diagnosis model of the air-conditioning system, and combining a basic environmental information of the chillers with operation parameters of the chillers and the pipe network flow data from existing environmental parameters.

The load prediction sub-module obtains hourly cooling load prediction value of the building by constructing a load prediction model of air-conditioning system, through activity information of the building occupant, the basic information and operation law of energy use equipment, the basic information and the turn-on law of the luminaire, the basic information of the building, and local weather parameters.

The optimization scheme sub-module integrates system operation parameters obtained in the system analysis sub-module and the building load hourly estimated value obtained in the load prediction sub-module, and establishes system optimization target parameters by constructing an optimization model of the air-conditioning system.

The control strategy sub-module combines control parameters output by the system analysis sub-module, load prediction sub-module, and optimization scheme sub-module to obtain optimal system commissioning control strategy, and realizes commissioning of air conditioning system by controlling and adjusting the number of running units, water supply temperature, frequency conversion, valve opening and terminal switch.

### Beneficial Effects of the Present Disclosure

1. Firstly, when implementing energy-saving retrofit of existing large public buildings, the first problem is how to judge whether the energy consumption level of the target building is higher than that of other similar buildings. The traditional method is judging based on experience or simple comparison with industry standard values, and the result has a large error. The system diagnosis of the present disclosure only needs to analyze historical data, and the result is more accurate and reliable.
2. Secondly, the question is how to focus the energy efficiency improvement on the most crucial parts with limited funds. The traditional commissioning process involves replacing equipment or even replacing the entire system. At the same time, due to the lack of attention to the commissioning of system operation, there are often problems of high cost and poor effects. The method proposed in this disclosure focuses on the commissioning of the system operation phase, and meanwhile the commissioning cost will be low.
3. A common problem raised in actual investigation work at present is that most of the existing public buildings' related information is seriously inadequate. How to conduct targeted commissioning is very critical to those buildings with severely lacking information. Most input parameters of the proposed method can be obtained through historical data collection or on-site measurement, and the requirements on the amount of information are relatively low.
4. Development of the commissioning expert system: based on the Visual Basic expert system design, it can simultaneously realize multiple functions such as preliminary multi-objective diagnosis of systems, building load hourly prediction, and determination of commissioning control strategies
5. Application in practical cases: evaluating the system through the commissioning tools, and based on the analysis results, providing the suggestions and references for the commissioning of the practical cases, which is helpful to find the best commissioning method. The disclosure can be conveniently combined with the energy consumption monitoring platform to realize integrated network control and adjust the host and other air-conditioning equipment according to the real-time load of large public buildings; and save energy as much as possible on the premise of ensuring indoor temperature and humidity. The air-conditioning operation control management system includes cooling and heat source (refrigeration host computer, boiler, etc.) control, pump (refrigerating pumps, cooling pumps, cooling water pumps, water supply pumps, etc.) control, terminal equipment (fresh air handling units, modular air conditioning units, fan-coil units, etc.) control and the control of various fans, valves, etc.

### BRIEF DESCRIPTION OF THE DRAWINGS

FIG. 1 is a principle flow chart of a low-cost commissioning system for the air-conditioning systems in existing large public buildings;

FIG. 2 is a technology roadmap of the development of a low-cost commissioning expert system for the air-conditioning systems in existing large public buildings;

FIG. 3 is an internal logic diagram of a low-cost commissioning system for the air-conditioning systems in existing large public buildings;

FIG. 4 is an algorithm flowchart of the diagnosis of an air conditioning system;

FIG. 5 is a flowchart of load prediction of an air conditioning system;

FIG. 6 is a schematic diagram of a fitting curve of the number of occupants;

FIG. 7 is a schematic diagram of a building lighting control mode;

FIG. 8 is a flowchart of an optimization target of the air conditioning system.

### EXAMPLES

A further detailed description of the present disclosure is made with the figures as follows:

Referring to FIG. 1, a principle flowchart of a low-cost commissioning system for the air-conditioning systems in existing large public buildings provided by the present disclosure. The specific implementation steps of each sub-module of the system are shown.

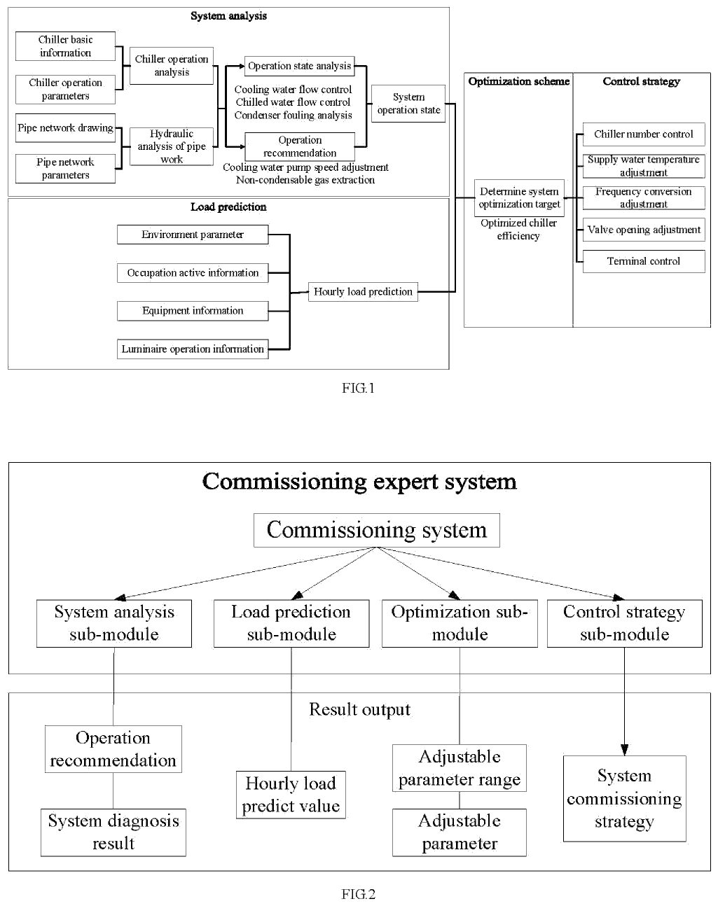

Referring to FIG. 2, the core modules of the commissioning system include a system analysis sub-module, a load prediction sub-module, an optimization scheme sub-module, and a control strategy sub-module. The system analysis sub-module includes system diagnosis results and operation recommendations. The output result of the load prediction sub-module contains the hourly estimated value of the building load. The output result of the optimization scheme sub-module includes adjustable target parameters and adjustable parameter ranges. The final control strategy sub-module outputs the optimal strategy of the system commissioning.

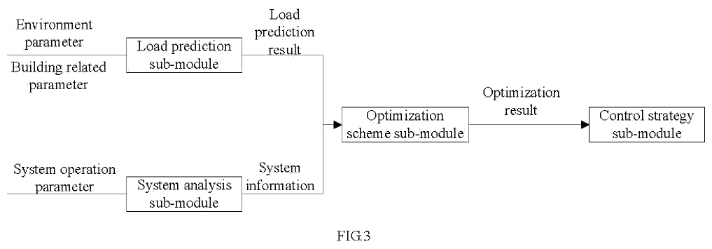

Referring to FIG. 3, in the commissioning system, the system analysis sub-module needs the operation parameters of the system, to analyze the system fault, and propose operation recommendations to obtain the normal operation parameters of the unit and the pipe network. The load prediction sub-module obtains the building load hourly estimated value through the environmental parameters, building-related information, the activity information of the building occupant, the usage situation of energy use equipment, and the turn-on condition of the luminaire. The optimization scheme sub-module combines the unit operation parameters obtained in the system analysis sub-module and the building load estimated results obtained in the load prediction sub-module to establish an optimization model, and finally passes the optimization results of all adjustable parameters to the control strategy sub-module.

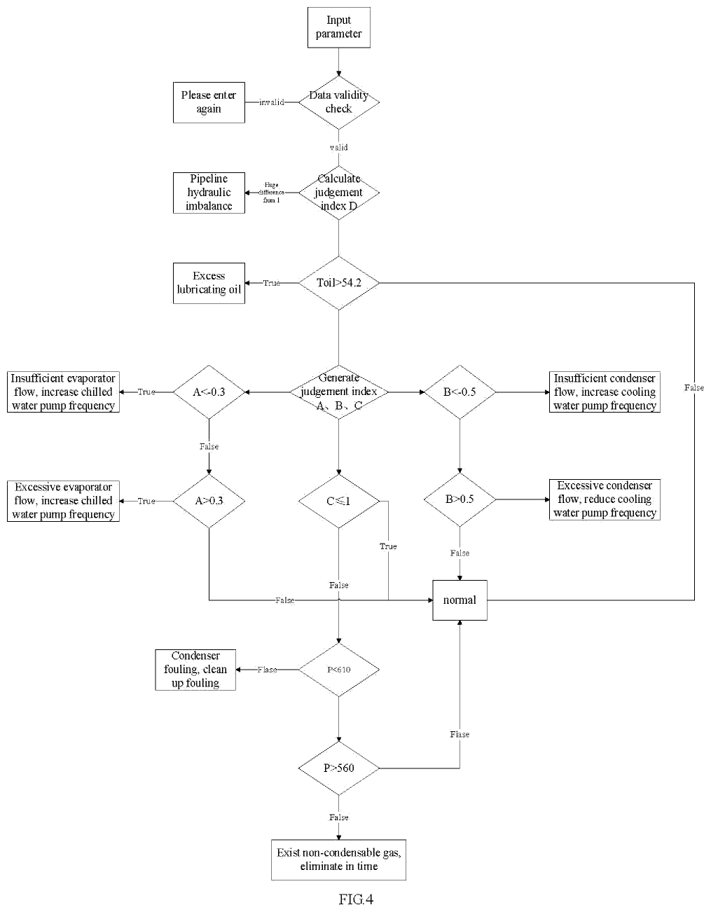

Referring to FIG. 4, an algorithm flowchart of the diagnosis of the air conditioning system.

Based on the air-conditioning system fault diagnosis model, the air-conditioning unit diagnosis results are obtained through the hourly operation parameters of the air-conditioning unit. The algorithm needs to input the following data: 1. Evaporation temperature (° C.) 2. Evaporator inlet water temperature (° C.) 3. Evaporator supply water temperature (° C.) 4. Condensation temperature (° C.) 5. Actual flow (m³/h) 6. Design flow (m³/h) 7. Condenser inlet water temperature (° C.) 8. Condenser supplywater temperature (° C.) 9. Unit power (W) 10. Lubricating oil tank oil temperature (° C.).

The program diagnosis algorithm is realized through the air-conditioning system fault diagnosis model. The specific model construction method is as follows:

First define the input variables: Tₑᵥ, evaporation temperature, ° C.; T_{chws}, evaporator supply water temperature, ° C.; T_{chwr}, evaporator return water temperature, ° C.; T_{cwe}, condenser return water temperature, ° C.; T_{cwl}, condenser supply water temperature, ° C.; T_{cd}, condensation temperature, ° C.; P, unit power, kW; Tₒᵢₗ, lubricating oil tank oil temperature, ° C.; Q_{s,i}, actual flow of the i-th parallel circuit loop m³/h, Q_{d,i}, design flow of the i-th parallel circuit loop m³/h.

Before the system diagnosis, the validity of the data must be judged. Since the input parameters must conform to the physical laws, the validity of the data can be judged by the following formula:

0<Tₑᵥ(evaporation temperature)<T_{chws}(evaporator supply water temperature)<T_{chwr}(evaporator return water temperature)<T_{cwe}(condenser return water temperature)<T_{cwl}(condenser supply water temperature)<T_{cd}(condensation temperature).

There are five main diagnostic goals: evaporator-side diagnosis, condenser-side diagnosis, non-condensable gas diagnosis, lubrication system diagnosis, and pipeline network hydraulic diagnosis. The specific implementation methods of diagnosis are as follows:

(1) Diagnosis of Water Volume on the Evaporator Side:

define judgment index A:

A=(T_{chwr}−T_{chws})−T₁ (1)

where, T₁ is the average value of the temperature difference between the return and supply water on the evaporator side, which is generally 2.5.

The diagnosis results are as follows:

if A>0.3, there is insufficient flow in the evaporator, and the frequency of the chilled water pump should be increased;

if −0.3<A<0.3, the evaporator works normally;

if A<−0.3, there is excessive flow in the evaporator, and the frequency of the chilled water pump should be reduced.

(2) Diagnosis of Water Volume on the Condenser Side:

define judgment index B:

B=(T_{cwt}−T_{cwe})−T₂ (2)

where T₂ is the average value of the temperature difference between the return and supply water on the condenser side, generally 2.5.

The diagnosis results are as follows:

if B>0.5, there is insufficient flow in the condenser, and the frequency of the cooling water pump should be increased;

if −0.3<B<0.3, the condenser works normally;

if B<−0.3, there is excessive flow in the condenser, and the frequency of cooling water pump should be reduced.

(3) Diagnosis of Non-Condensable Gas

define judgment index C:

C=T_{cd}−T_{cwl} (3)

The diagnosis results are as follows:

if C≤1, the system is normal;

if C>1 and 560<P<610, the system contains non-condensable gas, and the non-condensable gas in the system should be eliminated in time;

if C>1 and P>610, there is a possibility of fouling in the condenser, the condenser fouling should be cleaned in time.

(4) Diagnosis of Lubrication System

The diagnosis results are as follows:

if Tₒᵢₗ>54.2, the unit's lubricating oil is excessive. At this point, it should be recommended to extract excess oil from the oil tank.

(5) Diagnosis of Hydraulic Balance of Pipe Network

define judgment index D:

$${D}_{i} = \frac{{Q}_{s , i}}{{Q}_{d , i}} \qquad ( 4 )$$

The diagnosis results are as follows:

if Dᵢ is close to 1, the pipe network is hydraulic balanced;

if there is a large difference between Di and 1, there is a hydraulic imbalance in the pipe network. At this time, it is recommended to adjust the valves of different loops to ensure that the flow of each loop is close to the design flow.

It should be noted that the reasonable ranges of index A, B, and C are not fixed. The ranges given in the method are only representative of the normal situation. The actual values should be based on historical data or real-time monitoring data. The algorithm flow chart of the air conditioning system diagnosis model is shown in FIG. 1.

Refer to FIG. 5, a flowchart of load prediction of an air conditioning system under the load prediction sub-module in the commissioning system. Based on the load prediction model of the air-conditioning system, the hourly cooling load of the building is obtained through the activity information of the building occupant, the basic information and operation law of the energy use equipment, the basic information and the turn-on law of the luminaire, the basic information of the building, and local weather parameters. The specific model construction method is as follows:

### (1) Construction of Occupant Cooling Load Time-Varying Model

On the basis of a large amount of measured data of the occupant number in public buildings, it is found that during the normal opening time of a typical public building, the occupant number shows two typical characteristics over time. The first is that the occupant number has an obvious bimodal distribution, and the distribution is relatively stable. The trough between the two peaks is lunch break. The second is that the occupant number in the building is slightly different every day. The size and appearance time of the peak and the trough values fluctuate randomly within a certain range, and this random fluctuation can be cancelled by averaging the occupant number at the corresponding time for a long time (one week or more).

Through investigation, it was found that there are significant changes in the occupant number in the building during the morning active time period (08: 30-09: 30), lunch break (11: 20-13: 00), and off-hours time (17: 20-18: 00). However, during inactive hours (09: 30-11: 20 and 13: 00-17: 20), the occupancy rate fluctuated within a relatively small range:

For the three time periods in which the occupancy rate has changed greatly, it is considered that the distribution characteristics of the occupancy rate are consistent with the changing trend of the cubic polynomial curve. After obtaining the change in the average number of indoor people for each time period through the installation of the instrument, the following formula can be used to fit the occupancy rate:

Y=aX³+bX²+cX+d (5)

where y is the occupancy rate at different times; a, b, c, and d are model coefficients; x is time. Since time is not counted in decimal, the time of a day is first converted to a decimal number between 0 and 1. (For example, set 12:00 to 0.5 and 18:00 to 0.75), the conversion value is shown in Table 1:

TABLE 1
corresponding values of x at each time

| 0:00 | 1:00 | 2:00 | 3:00 | 4:00 | 5:00 | 6:00 | 7:00 | 8:00 | 9:00 | 10:00 | 11:00 |
|---|---|---|---|---|---|---|---|---|---|---|---|
| 0 | 0.0416 | 0.0833 | 0.125 | 0.1666 | 0.2083 | 0.25 | 0.2916 | 0.3333 | 0.375 | 0.4166 | 0.4583 |
| 12:00 | 13:00 | 14:00 | 15:00 | 16:00 | 17:00 | 18:00 | 19:00 | 20:00 | 21:00 | 22:00 | 23:00 |
| 0.5 | 0.5416 | 0.5833 | 0.625 | 0.6666 | 0.7083 | 0.75 | 0.7916 | 0.8333 | 0.875 | 0.9166 | 0.9583 |

During work time, the occupant number in the building basically changes steadily. The occupant number in this period can be directly measured by the instrument. Combined with the fitting curve, a time-varying model of the occupancy rate during office hours can be obtained.

Therefore, in making a long-term prediction for one week or one month, formula (4) can be used to determine the average hourly occupant number in the building. Cubic curve is fitted by software such as MATLAB to determine the values of the undetermined coefficients a, b, c, and d.

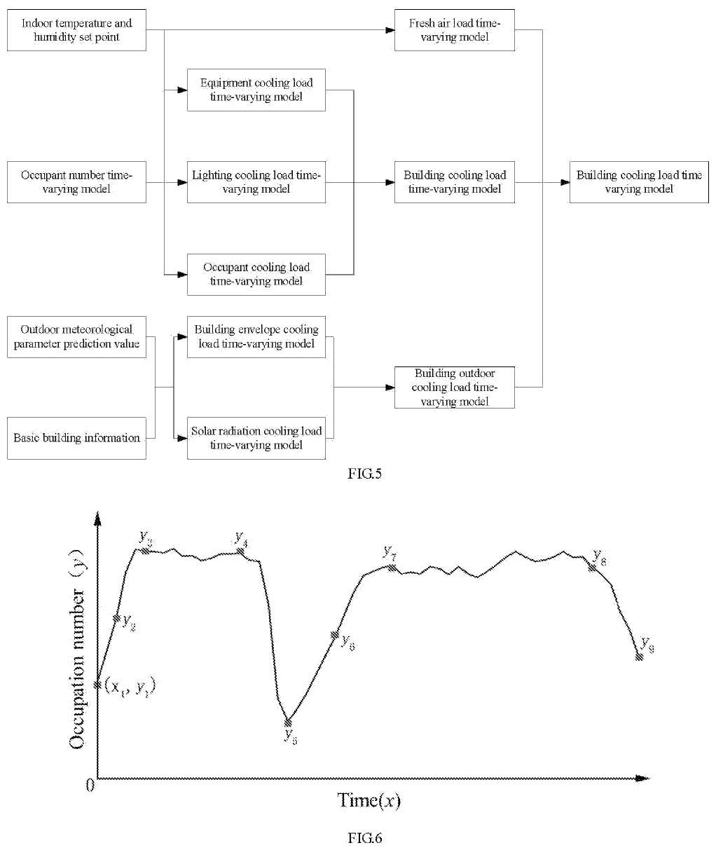

A large amount of measured data shows that the minimum value of the fitting coefficient of determination of the cubic curve fitting R\hat{ }2 is generally not less than 0.95, which can well reflect the changing curve of the occupancy rate. The fitting curve of the occupant number in the building is shown in FIG. 6.

### (2) Construction of Time-Varying Model of Equipment Cooling Load

To establish the time-varying load model of the equipment, the time-varying curve of the equipment power is needed.

Equipment can be divided into two categories, one type is frequently used equipment with large sample size, such as desktops, notebooks, and so on. This type of equipment is mainly single-person equipment, and the frequency of use is closely related to the work and rest behavior habits of users. The second type is intermittently used and a limited number of equipment, such as printers and water dispensers. This type of equipment is mainly public equipment, which is characterized by that people can share. The load of the second type accounts for a small proportion of the total equipment load. It is calculated by multiplying the safety factor on the basis of a single piece of equipment. According to the investigation, it is found that the load of the second type generally does not exceed 10% of the load of the first type of equipment. Therefore, the power of the second type of equipment is converted into the equipment conversion factor of the first type of equipment and the value is 1.1.

The rated power of the equipment is the rated power of a single-person equipment. Single-person equipment such as desktops, laptops have different rated power. The average value of the rated power of a single-person equipment can be calculated through questionnaires, field records, and other methods, which is used as the rated power of target equipment.

Through vast investigations on the use of equipment, it is found that the use of single-person equipment is inseparable from the number of indoor people, and the number of construction occupant corresponds to the single-person equipment. When the user is in working time, the corresponding single-person equipment is also working. The user will choose to close the corresponding single-person equipment only when he needs to leave the office area for a long time. Although the occupancy rate during lunch break has fallen sharply, most of the equipment is still working, and only a small number of equipment will be in standby or off. Therefore, the equipment load during lunch break is slightly decreased compared to that during working time. The measured data shows that the equipment load decrease during lunch break is generally not more than 10%, so the coefficient 0.95 is taken as the equipment load correction value during lunch break. After obtaining the time-varying curve of the equipment power, the cooling load of the indoor equipment of the office building can be calculated using the following formula:

$$\begin{matrix}{Q}_{e} = {q}_{e} {C}_{{LQ}_{e}} & ( 6 ) \\ {q}_{e} = \{ \begin{matrix}{n}_{1} {n}_{2} {N}_{e} Y & \begin{matrix}before and after work time \\ ( 0.35 \leq x \leq 0.42 , 0.72 \leq x \leq 0.75 )\end{matrix} \\ 0.95 {n}_{1} {n}_{2} {N}_{e} Y & lunch break ( 0.47 \leq x \leq 0.54 ) \\ {n}_{1} {n}_{2} {N}_{e} Y & on \text{-} work time\end{matrix} & ( 7 )\end{matrix}$$

where qₑ is the equipment heat dissipating capacity, W; C_{LQ}_{ₑ} is the cooling load coefficient for sensible heat dissipation of the equipment; n₁ is the use efficiency of a single equipment, and the value is 0.15 to 0.25; n₂ is the equipment conversion coefficient, and the value is 1.1; Nₑ is the rated power of a single equipment, W.

### (3) Construction of Hourly Cooling Load Model of Indoor Occupant

The occupant load is affected by factors such as labor intensity, gender, clothing, and the occupancy rate. The most important factor is the occupancy rate. The occupant load of a building can be calculated using the following formula:

Q_{c}=qₛYφC_{LQ} (8)

Where, Q_{c} is the hourly cooling load formed by human sensible heat dissipation, W; φ is clustering coefficient; C_{LQ} is the cooling load coefficient for sensible heat dissipation of human body; qₛ is the sensible heat dissipation capacity of adult men at different room temperature and with different labor characteristics, W.
The values of qₛ are shown in Table 2:

TABLE 2
Sensible heat dissipating capacity of an adult man

| | indoor temperature(° C.) | | | | | | | | |
|---|---|---|---|---|---|---|---|---|---|
| category | 20 | 21 | 22 | 23 | 24 | 25 | 26 | 27 | 28 |
| Sensible | 84 | 81 | 78 | 75 | 70 | 67 | 62 | 58 | 53 |
| heat qₛ(W) | | | | | | | | | |

### (4) Construction of Time-Varying Model of Lighting Cooling Load

The field investigation shows that when the working face illuminance does not meet the occupant demands, the light-on behavior will occur, but when the working face illuminance meets or even exceeds the working demands, there is no active light-off phenomenon. It can be seen that the relationship between occupant's control behavior of lighting and the illuminance on the work face is not a complete demand relationship, that is, the illuminance is only a driving factor for the light-on behavior of the occupant, and has no direct relationship with the light-off behavior.

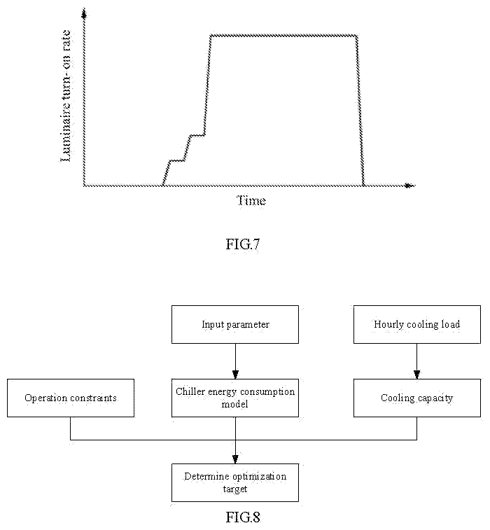

The lighting control mode of the building is on during on-work hours and off during off-work hours, but the turn-on mode of the lighting is not a simple one-on-all-on mode, but is controlled autonomously by occupant according to the area illumination. The turn-off mode of the lighting is a one-off-all-off mode, and the off-work time is the key node for occupant to turn off the lights. For buildings with multiple lighting partitions, the luminaire turn-on rate is calculated according to the following formula:

$${U}_{j} = \frac{{\sum }_{i = 1}^{j} {m}_{i}}{n} \times 100 \% j ∈ [ 1 , k ] \qquad ( 9 )$$

Where j is the number of lighting partitions; Uⱼ is the luminaire turn-on rate when j lighting partitions are turned on, %; k is the number of architectural lighting partitions; mᵢ is the number of luminaires in the i-th lighting partition; n is the total number of luminaires in lighting zones. The schematic diagram of the lighting control mode in the building is shown in FIG. 7.

Therefore, the lighting load of abuilding can be calculated using the following formula:

$${Q}_{L} = \{ \begin{matrix}0 & before work time 0 \leq x \leq 0.33 , y = 0 \\ α {U}_{j} {nW}_{L} {C}_{QL} & on \text{-} work time 0.33 \leq x \leq 0.83 , 0 < y \\ 0 & off \text{-} work time 0.83 \leq x \leq 1 , y = 0\end{matrix} \qquad ( 10 )$$

Where Q_{L} is the instantaneous cooling load of the lighting, W; a is the correction coefficient; W_{L} is the power required by the lighting fixture, W; C_{QL} is the cooling load coefficient for sensible heat dissipation of the lighting.

After obtaining the time-varying cooling load curves of equipment, occupant, and lighting, the interior cooling load of the building can be calculated using the following formula:

Qᵢ=Q_{c}+Qₑ+Q_{L} (11)

Since the time-varying models of equipment, occupant, and lighting cooling load are all time-varying models, the time-varying curve of the interior cooling load of the building can be obtained.

### (5) Construction of Cooling Load Time-Varying Model of Building Envelope

The model is built using the cooling load factor method. The hourly prediction values of temperature and humidity of outdoor air are obtained by checking the weather forecast website, and the cooling load of the building envelope is predicted by the prediction values. The specific calculation formula is as follows:

Qₜₛ=Σₖ₌₁^{SURF}(t_{τ}−tₙ)(AₖFₖ) (12)

Where: Qₜₛ is the hourly cooling load of the building envelope, W; A is the area of the building envelope, m²; SURF is the number of building envelope; F is the heat transfer coefficient of the building envelope, W/(m²·K); t_{τ} is the hourly outdoor air temperature, ° C.; tₙ is the indoor design temperature, ° C.

### (6) Construction of Solar Radiation Cooling Load Time-Varying Model

Solar radiation enters the room through the glass and becomes heat gain of the room. By combining the basic building information such as the structure of the external windows of the building through investigations with the solar heat gain of the windows given by the weather forecast website, the hourly prediction model of building solar radiation cooling load can be obtained. And the specific calculation formula is as follows:

Qₜᵣ=Σₖ₌₁^{EXP}(X_{g}X_{d}X_{z})Rᵢ (13)

Where Qₜᵣ is the hourly cooling load of solar radiation, W; R is the solar heat gain of the window, W/m²; X_{g} [symbol] X_{d} [symbol] X_{z} are the structure correction coefficient, location correction coefficient, and barrier coefficient of the window, EXP is the number of windows.

Establish a time-varying model of the exterior cooling load of the building. The exterior cooling load of the building is composed of the cooling load of the building envelope and the cooling load of solar radiation. After obtaining the building envelope and solar radiation cooling load prediction models, the time-varying model of the building exterior cooling load can be obtained. The specific calculation formula is as follows:

Qₜ=Qₜₛ+Qₜᵣ (14)

### (7) Establishing Time-Varying Model of Building Fresh Air Load

The fresh air load is related to the number of indoor occupant, and the fresh air supply temperature difference is related to the indoor design temperature. So the fresh air load is calculated separately. By combining the number of indoor occupant predicted by the obtained time-varying model of the occupancy rate with the prediction values of the outdoor temperature and humidity parameters, the building fresh air load time-varying model can be obtained.

$$\begin{matrix} {Q}_{f} = {Q}_{fs} + {Q}_{fl} & ( 15 ) \\ {Q}_{fs} = \{ \begin{matrix}{C}_{p} NyV ρ ( {t}_{τ} - {t}_{n} ) & on \text{-} work time 0.33 \leq x \leq 0.83 , 0 < Y \\ 0 & before work time 0 \leq x \leq 0.33 , Y = 0 \\ 0 & off \text{-} work time 0.83 \leq x \leq 1 , Y = 0\end{matrix} & ( 16 ) \\ {Q}_{fl} = \{ \begin{matrix}{r}_{t} NyV ρ ( {d}_{τ} - {d}_{n} ) & on \text{-} work time 0.33 \leq x \leq 0.83 , 0 < Y \\ 0 & before work time 0 \leq x \leq 0.33 , Y = 0 \\ 0 & off \text{-} work time 0.83 \leq x \leq 1 , Y = 0\end{matrix} & ( 17 )\end{matrix}$$

Where Q_{f} [symbol] Q_{fs} [symbol] Q_{fl} ware fresh air load, sensible heat load, and latent heat load, respectively, W/m²; dₜ [symbol] dₙ are outdoor air humidity and indoor air humidity, respectively, kg (water)/kg(dry air); Cₚ is the specific heat capacity of the air, 1.01 kJ/kg; p is the air density, 1.293 g/m³V is the fresh air volume required by a single person, and the size is 30 m³/(h·person); rₜ is the latent heat of vaporization of water, 1718 kJ/kg.

After obtaining the time-varying model of the building outdoor cooling load, the time-varying model of the building indoor cooling load and the fresh air load time-varying model, by adding the three parts of the load, the time-varying model of the indoor cooling load can be obtained.

Q=Qᵢ+Qₜ+Q_{f} (18)

Referring to FIG. 8, a flowchart of an optimization target of the air conditioning system under the optimization scheme sub-module of the present disclosure. Through the hourly cooling load of the building (obtained from the load prediction) and the historical data of the unit operation, the optimal target value of the unit operation is obtained.

Constructing the air-conditioning system optimization model. The specific steps are as follows:

First, establishing the mathematical models of the chiller, the chilled water pump and the cooling water pump.

The energy consumption of the chiller is related to the chilled water supply temperature, the cooling water supply temperature and the actual cooling capacity. Here it is still assumed that the energy consumption of the chiller is related to the above variables, but when analyzing the cooling season conditions, the chilled water supply temperature is the chilled water supply temperature (from the evaporator to the ground source side), the cooling water supply temperature is the cooling water supply temperature (from the condenser to the user side), and the actual cooling capacity is obtained by using the cooling water side flow and the temperature difference between the supply and return water.

P₁=c₁+c₂·T₁+c₃·T₂+c₄·Q (19)

Where: P₁-energy consumption of the water chiller, kW;
c₁, c₂, c₃ and c₄-parameters of each item;
T₁—chilled water supply temperature, ° C.;
T₂—cooling water return temperature, ° C.;
Q—actual cooling capacity, kW.

The cooling water side and chilled water side pump energy consumption models.

The literature points out that the energy consumption of the pump is related to the actual flow and speed ratio of the pump. Based on public building investigation, it is found that the pump has always been running at a fixed frequency and the speed ratio does not change. Therefore, this disclosure assumes that the energy consumption of the pump is only related to the actual flow of the pump. The energy consumption expression is shown in formula (19).

P₂=g₁+g₂·m (20)

Where:

P₂—Energy consumption of cooling water side and chilled water side pumps, kW

g₁, g₂—parameters of each item;

m—actual flow of the pump, m3/h;

After obtaining the actual monitoring data of the building operation, the parameters in the formulas (18) and (19) can be discriminated using the least square method in MATLAB.

The energy consumption model of the HVAC system is the sum of the energy consumption of the above three equipment. When the load is determined at a certain time the energy consumption of the HVAC system can be the lowest. Find the values of various parameters of the system that can minimize energy consumption, that is, the optimal working point of the system.

However, when seeking the optimal working point of the system, the values of various parameters should be within the correct range, that is, the value of each parameter should be constrained.

The constraint are as follows:

TABLE 3
Constraint condition setting result table

| Constraint item | max | min |
|---|---|---|
| Cooling water supply temperature | 45 | 40 |
| (° C.) | | |
| Cooling water return temperature | 45 | 35 |
| (° C.) | | |
| Cooling water supply and return | 7 | 2 |
| temperature difference (° C.) | | |
| Chilled water inlet temperature | 15 | 8 |
| (° C.) | | |
| Chilled water supply temperature | 15 | 5 |
| (° C.) | | |
| Cooling water supply and return | 7 | 2 |
| temperature difference (° C.) | | |
| cooling water side pump flow | 60 | 20 |
| (m³/h) | | |
| chilling water side pump flow | 80 | 20 |
| (m³/h) | | |

Note:
The constraint conditions given in the table are for reference only. The specific values should be set according to the actual situation of the unit.

The purpose of the energy consumption optimization is to seek the values of various parameters of the system when the energy consumption reaches the minimum value, that is, the optimal working point of the system. The cooling load value can be obtained using the cooling load prediction model; after determining the cooling water supply and return temperature, the cooling water flow can also be determined; after determining the chilled water inlet and supply temperature, the chilled water flow can also be determined. Therefore, the total energy consumption of the HVAC system is related to the four variables of the cooling water supply and return water temperature and the chilled water return and supply temperature. The optimization algorithm is to determine the values of the four variables when the energy consumption reaches the minimum value, which is the optimal working point of the HVAC system under this load level.

The optimization algorithm is obtained through programming in MATLAB 2014a. The program is a simple for loop statement and if and else statements. The algorithm is simple and easy to understand, and runs fast, which can provide timely guidance strategies for operation management. The optimization algorithm process is as follows.

(1) Set the normal operating ranges of the cooling water supply and return temperature, the chilled water supply and return temperature, the cooling water supply and return temperature difference, the chilled water supply and return temperature difference, the cooling water flow and the chilled water flow.
(2) Establish an expression for the energy consumption of HVAC system, which is related to the cooling water supply and return temperature, chilled water supply and return temperature, and cooling load;
(3) Input the cooling load value at the predicted time. The program will randomly select a set of parameters in the cooling water supply and return temperature and the chilled water supply and return temperature to calculate the energy consumption value and record it as E1; compare E1 to a reference value, which is much greater than the possible energy consumption value. If E1 is less than the reference value, then the reference value is replaced by E1 as the reference energy consumption value for further calculation;
(4) Continue to randomly select a set of parameters to calculate the energy consumption value and record it as E2. If E2 is less than E1, E1 is replaced by E2 as the reference energy consumption value; if E2 is greater than E1, then retain E1 as the reference energy consumption value;
(5) Continue the process in (4) until the minimum energy consumption value Ei is found, and output it together with the corresponding parameter group.

The input parameters of this disclosure include: historical data or real-time monitoring data of hourly operation parameters of air-conditioning units, construction occupant activity information, the basic information and operation law of the energy use equipment, the basic information and the turn-on law of the luminaire, the basic information of the building, and local weather parameters. Before commissioning the system, the information of above input parameters needs to be collected, and the authenticity of the commissioning results is closely related to the accuracy of the input parameters. The parameters of the air-conditioning unit are mainly: evaporation temperature, evaporator supply water temperature, evaporator inlet water temperature, condenser inlet water temperature, condenser supply water temperature, condensation temperature, unit power, lubricating oil tank oil temperature, air-conditioning side pump flow, and ground side pump flow. Under the premise of an energy consumption monitoring platform, historical data can be used for calculation or real-time monitoring can be used instead; occupant activity information can be obtained by means of infrared counter. Basic building information includes basic information of equipment type, number of units and power, building area, temperature and humidity of interior design, and building envelope. Usage information includes office work and rest time, equipment usage habits, number and power of luminaires. The outdoor meteorological parameters are prediction values and are provided by the regional meteorological bureau where the target office is located. If the use of the building is periodical, it is necessary to set input parameters for each period respectively for load prediction (for example, there can be different usage laws on weekdays and weekends, winter and summer). Because the input parameters are set for the situation of the target building, the commissioning model is more practical and more reliable. The disclosure can be used for the commissioning of the air-conditioning system in the stable operation time of the existing large public buildings, and at the same time, it can give the system diagnosis results, load demand estimation and optimization target calculation. This method is simple and easy to implement, has strong generalizability, and has strong reference value.

It shall be understood that the embodiments and examples discussed herein are for illustration only. Those skilled in this art may make improvements or changes based on this disclosure, but all these improvements and changes shall fall within the protection scope of the appended claims of the present disclosure.

1. A method of low-cost commissioning for air-conditioning system in existing large public buildings, commissioning strategy of air-conditioning system, comprising:
constructing fault diagnosis model for air-conditioning unit, constructing load prediction model for air-conditioning and constructing optimization model for air-conditioning system;
specific steps of constructing the fault diagnosis model for air-conditioning unitare, comprising:
first, define input variables: Tₑᵥ, evaporation temperature, ° C.; T_{chws}, evaporator supply water temperature, ° C.; T_{chwr}, evaporator inlet water temperature, ° C.; T_{cwe}, condenser inlet water temperature, ° C.; T_{cwt}, condenser supply water temperature, ° C.; T_{cd}, condensation temperature, ° C.; P, unit power, kW; Tₒᵢₗ, lubricating oil tank oil temperature, ° C.; Q_{s,i}, actual flow of i-th parallel circuit loop, m³/h; Q_{d,i}, design flow of i-th parallel circuit loop, m³/h;
(1) diagnosis of water volume on evaporator side:
define judgment index A:
A=(T_{chwr}−T_{chws})−T₁ (1)
where T₁ is an average value of temperature difference between the inlet and supply water on the evaporator side, which is generally 2.5,
diagnosis results are as follows:
if A>0.3, there is insufficient flow in the evaporator, and frequency of chilled water pump should be increased;
if −0.3<A<0.3, the evaporator works normally;
if A<−0.3, there is excessive flow in the evaporator, and frequency of the chilled water pump should be reduced;
(2) diagnosis of water volume on condenser side:
define judgment index B:
B=(T_{cwl}−T_{cwe})−T₂ (2)
where T₂ is an average value of temperature difference between the inlet and supply water on the condenser side, generally 2.5;
diagnosis results are as follows:
if B>0.5, there is insufficient flow in the condenser, and frequency of cooling water pump should be increased;
if −0.3<B<0.3, the condenser works normally;
if B<−0.3, there is excessive flow in the condenser, and the cooling water pump frequency should be reduced;
(3) diagnosis of non-condensable gas
define judgment index C:
C=T_{cd}−T_{cwl} (3)
diagnosis results are as follows:
If C≤1, system is normal;
if C>1 and 560<P<610, the system contains non-condensable gas, and the non-condensable gas in the system should be eliminated in time;
if C>1 and P>610, there is a possibility of fouling in the condenser, and the condenser fouling should be cleaned in time;
(4) diagnosis of lubrication system
diagnosis results are as follows:
if Tₒᵢₗ>54.2, an unit's lubricating oil is excessive; at this point, it should be recommended to extract excess oil from oil tank;
(5) diagnosis of hydraulic balance of pipe network
define judgment index D:
$${D}_{i} = \frac{{Q}_{s , i}}{{Q}_{d , i}} \qquad ( 4 )$$
diagnosis results are as follows:
if Dᵢ is close to 1, a pipe network is hydraulically balanced;
if there is a large difference between Di and 1, there is a hydraulic imbalance in the pipe network;
it is recommended to adjust valves of different loops to ensure that flow of each loop is close to design flow.

2. The method of claim 1, wherein specific steps of constructing load prediction model for air-conditioning are as follows:
first, build a model for occupant number in the building;
typical day can be divided into four time periods, morning active time period (08:30-09:30), noon break time period (11:20-13:00), afternoon active time period (17:20-18:00) and inactive time period (09:30-11:20 and 13: 00-17: 20);
obtaining weekly average occupant number of each time period, the following formula can be used to fit hourly occupancy in active time periods:
Y=aX³+bX²+cX+d (5)
where Y is occupant number, X is time; a, b, c, d are fitting coefficients; the occupant number in inactive time period is considered to be basically maintained in a stable state, a value at last moment of previous active time period is used as the occupant number of inactive time period;
further, construct cooling load prediction model of equipment:
$$\begin{matrix}{Q}_{e} = {q}_{e} {C}_{{LQ}_{e}} & ( 6 ) \\ {q}_{e} = \{ \begin{matrix}{n}_{1} {n}_{2} {N}_{e} Y & \begin{matrix}before and after work time \\ ( 0.35 \leq x \leq 0.42 , 0.72 \leq x \leq 0.75 )\end{matrix} \\ 0.95 {n}_{1} {n}_{2} {N}_{e} Y & lunch break ( 0.47 \leq x \leq 0.54 ) \\ {n}_{1} {n}_{2} {N}_{e} Y & on \text{-} work time\end{matrix} & ( 7 )\end{matrix}$$
where qₑ is heat dissipated by equipment, W; C_{LQ}_{ₑ} is cooling load coefficient for sensible heat dissipation of the equipment; n₁ is efficiency of a single equipment, which is 0.15 to 0.25; n₂ is equipment conversion coefficient, which is 1.1; Nₑ is rated power of a single equipment, W;
establish time-varying model of occupant cooling load as follows:
Q_{c}=q_{z}YφC_{LQ} (8)
where Q_{c} is hourly cooling load formed by human body sensible heat dissipation, W; qₛ is sensible heat dissipation capacity of adult men at different room temperature and with different labor characteristics, W; φ is clustering coefficient; C_{LQ} is cooling load coefficient for sensible heat dissipation of human body;
the specific steps for establishing time-varying model of lighting cooling load ae as follows:
1) building with multiple lighting partitions, luminaire turn-on rate is calculated according to the following formula:
$${U}_{j} = \frac{{\sum }_{i = 1}^{j} {m}_{i}}{n} \times 100 \% j ∈ [ 1 , k ] \qquad ( 9 )$$
where j is number of lighting partitions; Uⱼ is luminaire turn-on rate with j lighting partitions are turned on, %; k is number of architectural lighting partitions; mᵢ is number of luminaires in the i-th lighting partition; n is total number of luminaires in lighting zones;
2) lighting cooling load of a building can be calculated using the following formula:
$${Q}_{L} = \{ \begin{matrix}0 & before work time 0 \leq x \leq 0.33 , y = 0 \\ α {U}_{j} {nW}_{L} {C}_{QL} & on \text{-} work time 0.33 \leq x \leq 0.83 , 0 < \\ 0 & off \text{-} work time 0.83 \leq x \leq 1 , y = 0\end{matrix} \qquad ( 10 )$$
where Q_{L} is instantaneous cooling load of lighting, W; α is correction coefficient; W_{L} is power required by lighting fixture, W; C_{QL} is cooling load coefficient for sensible heat dissipation of the lighting;
building interior cooling load calculation formula is as follows:
Qᵢ=Q_{c}+Qₑ+Q_{L} (11)
cooling load prediction model of building envelope is as follows:
Qₜₛ=Σₖ₌₁^{SURF}(t_{τ}−tₙ)(AₖFₖ) (12)
where Qₜₛ is hourly cooling load of the building envelope, W; A is area of the building envelope, m²; SURF is number of the building envelope; F is heat transfer coefficient of the building envelope, W/(m²·K); t_{τ} is hourly outdoor air hourly temperature on calculated daily, ° C.; tₙ is indoor design temperature, ° C.;
solar radiation cooling load prediction model is as follows:
Qₜᵣ=Σₖ₌₁^{EXP}(X_{g}X_{d}X_{z})Rᵢ (13)
where Qₜᵣ is hourly cooling load of solar radiation, W; R is solar heat gain of window, W/m²; X_{g} [symbol] X_{d} [symbol] , X_{z} are structure correction coefficient, location correction coefficient and barrier coefficient of window, respectively; EXP is the number of window;
building exterior cooling load prediction model is as follows:
Qₜ=Qₜₛ+Qₜᵣ (14)
building fresh air load prediction model is as follows:
$$\begin{matrix} {Q}_{f} = {Q}_{fs} + {Q}_{fl} & ( 15 ) \\ {Q}_{fs} = \{ \begin{matrix}{C}_{p} NyV ρ ( {t}_{τ} - {t}_{n} ) & on \text{-} work time 0.33 \leq x \leq 0.83 , 0 < Y \\ 0 & before work time 0 \leq x \leq 0.33 , Y = 0 \\ 0 & off \text{-} work time 0.83 \leq x \leq 1 , Y = 0\end{matrix} & ( 16 ) \\ {Q}_{fl} = \{ \begin{matrix}{r}_{t} NyV ρ ( {d}_{τ} - {d}_{n} ) & on \text{-} work time 0.33 \leq x \leq 0.83 , 0 < Y \\ 0 & before work time 0 \leq x \leq 0.33 , Y = 0 \\ 0 & off \text{-} work time 0.83 \leq x \leq 1 , Y = 0\end{matrix} & ( 17 )\end{matrix}$$
where Q_{f} [symbol] Q_{fs} [symbol] Q_{fl} are fresh air load, sensible heat load and latent heat load, respectively, W/m²; dᵣ [symbol] dₙ are outdoor air humidity and indoor air humidity, respectively, kg(water)/kg(dry air); Cₚ is specific heat capacity of air, 1.01 kJ/kg; ρ is air density, 1.293 g/m³; V is fresh air volume required by a single person, which is 30 m³/(h·person); rₜ is latent heat of vaporization of water, 1718 kJ/kg;
hourly cooling load model of the building is as follows:
Q=Qᵢ+Qₜ+Q_{f} (18)
in the case of long-term operation, cooling capacity of unit and building load should maintain a dynamic balance; it is considered that the cooling capacity of unit is equal to cooling load of the building.

3. The method of claim 1, wherein specific steps of constructing optimization model for air-conditioning system are as follows:
first, construct an energy consumption model of chillers;
the energy consumption of the chillers can be obtained by the following formula fitting:
P₁=c₁+c₂·T₁+c₃·T₂+c₄·Q (19)
where P₁—energy consumption of chillers, kW;
c₁ [symbol] c₂ [symbol] c₃ and c₄-parameters of each item;
T₁—chilled water supply temperature, ° C.;
T₂—cooling water return temperature, ° C.;
Q-actual cooling capacity, kW;
cooling water side pump and chilled water side pump energy consumption models can use:
model of cooling water pump and chilled water pump is as follows:
P₂=g₁+g₂·M (20)
where P₂—Energy consumption of cooling water pump or chilled water pump, kW;
g₁, g₂—parameters of each item;
m—actual flow of the pump, m³/h;
energy consumption of air-conditioning system is the sum of energy consumption of the above three equipment;
when the cooling load of building is determined at a certain moment, optimal working point with the lowest system energy consumption can be determined by the optimization algorithm and corresponding constraint condition;
specific process of the algorithm is as follows:
(1) set normal operating ranges of the cooling water supply and return temperature, chilled water supply and return temperature, cooling water supply and return temperature difference, chilled water supply and return temperature difference, cooling water flow and chilled water flow;
(2) establish an expression for the energy consumption of HVAC system, which is related to the cooling water supply and return temperature, chilled water supply and return temperature, and cooling load;
(3) input cooling load value at predicted time; program will randomly select a set of parameters of the cooling water supply and return temperature and the chilled water supply and return temperature to calculate the energy consumption value and record it as E1; compare E1 to a reference value, which is much greater than possible energy consumption value;
if E1 is less than reference value, then the reference value is replaced by E1 as reference energy consumption value for further calculation;
(4) randomly select a set of parameters to calculate the energy consumption value and record it as E2;
if E2 is less than E1, E1 is replaced by E2 as reference energy consumption value;
if E2 is greater than E1, then retain E1 as reference energy consumption value;
(5) continue the process in (4) until the minimum energy consumption value Ei is found, and output it together with the corresponding parameter group.

4. The method of claim 1, wherein the commissioning system comprising:
a system analysis sub-module, a load prediction sub-module, an optimization scheme sub-module and a control strategy sub-module;
the system analysis sub-module obtains a preliminary analysis of operation status of chillers and a hydraulic analysis of the pipe network by constructing a fault diagnosis model of the air-conditioning system, and combining a basic information of the chillers with operation parameters of the chillers and the pipe network flow data from existing environmental parameters;
the load prediction sub-module obtains hourly cooling load prediction value of the building by constructing a load prediction model of air-conditioning system, through activity information of the building occupant, the basic information and operation law of energy use equipment, the basic information and the turn-on law of luminaire, the basic information of building, and local weather parameters;
the optimization scheme sub-module integrates system operation parameters obtained in the system analysis sub-module and estimated hourly building load value obtained in the load prediction sub-module, and establishes system optimization target parameters by constructing an optimization model of the air-conditioning system;
the control strategy sub-module combines control parameters output by the system analysis sub-module, load prediction sub-module, and optimization scheme sub-module to obtain optimal system commissioning control strategy, and realizes commissioning of air conditioning system by controlling and adjusting the number of start-stop units, water supply temperature, frequency conversion, valve opening and end switch.
